(19) United States
(12) Patent Application Publication
(10) Pub. No.: US 2008/0029168 A1
(43) Pub. Date: Feb. 7, 2008

(54) MULTI-PORT FLUID DISTRIBUTION

(76) Inventor: John A. Kinlaw, Friendsville, TN (US)

Correspondence Address: LUEDEKA, NEELY & GRAHAM, P.C., P O BOX 1871, KNOXVILLE, TN, 37901, US

(21) Appl. No.: 11/461,822

(22) Filed: Aug. 2, 2006

(51) Int. Cl. F16K 11/00

(52) U.S. Cl. 137/597

(57) ABSTRACT

The invention relates to a fluid distribution apparatus and method. The various embodiments of the fluid distribution apparatus comprise a core and a housing by which at least two input fluid streams may be selectively directed through two or more input ports to two or more output ports such that external attachments to the apparatus may remain substantially fixed and whereby substantially no input port or output port is left unused.

### FIELD OF THE INVENTION

This invention relates to the field of fluid exchange, and more particularly, the invention relates to an apparatus and method for improving multi-port fluid distribution.

### BACKGROUND OF THE INVENTION

With heightened requirements for maximizing space, minimizing idle pipe structure, minimizing the number of necessary piping connections, and minimizing process error, an increased need has developed for devices that can easily and efficiently operate as fluid flow and exchange devices. Such devices are used in a wide array of industries. Fluid flow and exchange devices are commonly used in the chemical-related industries because multiple streams of various fluids must often be managed, directed, and safely contained in a labyrinth of piping or similar conduit structures. A device commonly used in the structure of such fluid systems is a multi-port valve.

In many industries, multiple fluid streams are directed to varying destinations based on a schedule or “duty.” Each physical point at which one or more fluids are re-directed to a new destination could be thought of as an exchanging hub. With an increasing number of fluid streams to be exchanged comes a dramatic increase in exchanging hub complexity. Increases in exchanging hub complexity require an increase in the number of multi-port valves used, thereby taking up a great deal of space because of extra piping and increasing the chance for errors during a when fluid stream paths are alternated.

One example of such use of multi-port valves includes the use in ion exchange reaction systems. Often, multiple ion exchange columns will be used simultaneously in a parallel formation and series operation. A three-column system is commonly employed. While a first column is exchanging ions with a feed material (“feed” step), a second column may be undergoing a reconditioning step (in parallel), while the third column performs a “polishing” step (in series with the first column). When the feed step is substantially complete, the first column must then undergo a reconditioning step. After the reconditioning step, the first column performs the polishing step, and then the cycle begins again. To maximize efficiency, the feed, recondition, and polishing steps are simultaneously performed in a stepwise fashion in one of the three columns, thereby minimizing down time for each column. The valves progress or “rotate” through the cycle of steps repeatedly in this example. This rotation is often called a “duty cycle.”

Continuing with the example above, a minimum of twelve traditional multi-port valves, each with one inlet port and four outlet ports, are required for a three-column ion exchange system. If single port valves were used, over thirty valves would be required. In either case, the opportunity for error is heightened because of the large number of valves necessary to rotate the process through the required duty cycle. Moreover, with an increased number of valves comes an increase in piping and the undesirable presence of idle piping (commonly referred to as “deadlegs”).

Many industries utilize processes that require a duty rotation of fluid streams through piping systems. In these industries as well as in the ion exchange example given above, there is a need to, inter alia, minimize the number of multi-port valves in order to maximize space, decrease the potential for errors, and minimize undesirable deadlegs.

### SUMMARY

The present invention is an apparatus and method that satisfies this need. More specifically, various embodiments of the invention are directed to a valve that includes a core and a housing. The housing covers part or substantially all of the core. The core contains a plurality of cavities and a plurality of openings. The cavities are connected to the openings by a plurality of conduits. Each cavity remains in fluid communication with a separate opening via an individual conduit.

The housing includes a plurality of primary ports and a plurality of secondary ports. The primary ports correspond with the plurality of cavities. Each primary port remains in constant fluid communication with a separate cavity. The secondary ports correspond with the plurality of openings. Unlike the primary ports, the secondary ports do not remain in constant fluid communication with a specific opening. In contrast, the core and housing unite relative to one another such that the secondary ports are in transient fluid communication with the openings. More specifically, a first secondary port will remain in fluid communication with a first opening for a temporary period of time, the core and the housing will move relative to another, and then the first secondary port will be in temporary fluid communication with a second opening. In a preferred embodiment, the number of openings is equal to the number of secondary ports. It should be understood that the relative movement described above between the core and the housing does not require that both the core and the housing be moved relative to a third body. Rather, the core may be moveable within a stationary housing or, vice versa, the housing may be moveable about a stationary core.

The embodiment of the invention described above allows for a plurality of inlet streams to enter the valve housing via the plurality of primary ports. Those same respective streams exit the valve through the secondary ports. However, the valve allows for a first stream initially traveling into a first primary port and out of a first secondary port to be re-directed from out of the first secondary port to out of a second secondary port. The first stream remains in fluid communication with the first primary port during the entire process. At the same time, the valve allows for a second stream initially traveling into a second primary port and out of the second secondary port to be re-directed from out of the second secondary port to out of a third secondary port (or back to the first secondary port, depending on how many primary ports and secondary ports are used with the given application). The second stream remains in fluid communication with the second primary port during the entire process. Because the primary ports stay in constant fluid communication with the plurality of first cavities, there is no need to move or change fluid lines carrying streams to the valve; these lines can remain attached to their respective primary port at all times. Similarly, lines connected to the secondary ports can remain attached to their respective secondary port at all times because the valve can redirect the respective flows of the streams to each line according to a desired sequential duty rotation.

If a particular duty rotation requires three separate sequential steps, an embodiment of the invention can be selected including a valve with three primary ports and three secondary ports. Similarly, if a particular duty rotation requires X separate sequential steps, an embodiment of the invention can be selected including a valve with X primary ports and X secondary ports. It should be understood by those skilled in the art, however, that the number of steps in a duty rotation does not necessarily correspond with the number of primary ports, cavities, conduits, openings, and secondary ports needed on a valve as described in this disclosure. An embodiment with X primary ports and Y secondary ports could be employed. For example, a four-part duty cycle may require a first input stream of Material A to be introduced into a system every other step. A stream of Material B may be required every fourth step and a stream of Material C may be required every fourth step. The pattern would, therefore, be as follows: Material A, Material B, Material A, Material C. In such a system, only three primary ports and three cavities would be required. However, four conduits, four openings, and four secondary ports would be required.

The present invention is also directed to a fluid distribution and processing apparatus that satisfies the general needs described above in the context of ion exchange systems and the use of a duty rotation. One embodiment of the distribution and processing apparatus includes a portion of a three-column ion exchange system that undergoes a three-part duty rotation including the sequential steps of Feed, Recondition, and Polish.

The system using the method of this embodiment of the invention includes three supply streams named for each duty: “Feed,” “Recondition,” and “Polish.” Each individual supply stream is directed to three separate primary ports located on the housing of a first valve. The first valve is a valve like the valves described in other embodiments of the invention. Feed is directed to a first primary port, Recondition is directed to a second primary port, and Polish (Feed effluent) is directed to a third primary port. For example, in a first step of the three-part duty rotation cycle, Feed flows into the first primary port, into a first cavity, through a first conduit, out of a first opening, and out of a first secondary port to a first column in the ion exchange process. At substantially the same time, Recondition flows into the second primary port, into a second cavity, through a second conduit, out of a second opening, and out of a second secondary port to a second column in the ion exchange process. At substantially the same time, Polish flows into the third primary port, into a third cavity, through a third conduit, out of a third opening, and out of a third secondary port to a third column in the ion exchange process.

As the Feed flows through the first column, Recondition flows through the second column and Polish flows through the third column. The outflows of each column are directed to a second valve. In this example, a first Feed Effluent flows from the first column (becoming the Polish for the third column), a first Recondition Effluent flows from the second column, and a first Polish Effluent flows from the third column.

The second valve is substantially identical to the first valve; however, the respective flows through the second valve move through the second valve in the opposite manner than with the first valve. For clarity in this example, components that are meant to designate the first valve will be designated by “(V1)” and components that are meant to designate the second valve will be designated by “(V2).” More specifically, the first column effluent is directed to a first secondary port of (V2). The second column effluent is directed to a second secondary port (V2). The third column effluent is directed to a third secondary port (V2). The respective effluent streams of each column are not only identified by the column that they came from but by the particular step in the duty cycle or “batch” from which the effluent streams were generated. This will become more apparent as various embodiments of the invention are described in more detail.

The first column effluent flows through the first secondary port (V2), a first opening (V2), a first conduit (V2), a first cavity (V2), and a first primary port (V2). The second column effluent flows through the second secondary port (V2), a second opening (V2), a second conduit (V2), a second cavity (V2), and a second primary port (V2). The third column effluent flows through the third secondary port (V2), a third opening (V2), a third conduit (V2), a third cavity (V2), and a third primary port (V2). Feed effluent, the contents of the first batch of the first column effluent, is distributed from the first primary port (V2) directly to the first primary port (V1) (or, alternatively, to a Feed effluent collection chamber). Recondition effluent, the contents of the first batch of the second column effluent, is distributed from the second primary port (V2) to a Recondition effluent collection chamber. Polish effluent, the contents of the first batch of the third column effluent, is distributed from the third primary port (V2) to a Polish effluent collection chamber.

When the time comes for the ion exchange system to change duties for each ion exchange column, the core and the housing of the first valve are moved relative to each other to accomplish the following: Feed continues to be directed to the first primary port, Recondition continues to be directed to the second primary port, and Polish (Feed effluent) continues to be directed to the third primary port. Feed flows into the first primary port, into the first cavity, through the first conduit, out of the first opening, and out of the third secondary port to the third column in the ion exchange process. At the same time, Recondition flows into the second primary port, into the second cavity, through the second conduit, out of the second opening, and out of the first secondary port to the first column in the ion exchange process. At the same time, Polish (Feed effluent) flows into the third primary port, into the third cavity, through the third conduit, out of the third opening, and out of the second secondary port to the second column in the ion exchange process. As the Feed flows through the third column, Recondition flows through the first column, and Polish flows through the second column, the outflows of each column are directed to the second valve.

When the time comes for the ion exchange system to change duties for each ion exchange column and substantially when the first valve is manipulated, the core and the housing of the second valve are moved relative to each other to accomplish the following: The first column effluent continues to be directed to the first secondary port (V2). The second column effluent continues to be directed to the second secondary port (V2). The third column effluent continues to be directed to the third secondary port (V2). The first column effluent flows through the first secondary port (V2), the third opening (V2), the third conduit (V2), the third cavity (V2), and the third primary port (V2). The second column effluent flows through the second secondary port (V2), the first opening (V2), the first conduit (V2), the first cavity (V2), and the first primary port (V2). The third column effluent flows through the second secondary port (V2), the second opening (V2), the second conduit (V2), the second cavity (V2), and the second primary port (V2). Feed effluent from the second batch is no longer in the first column effluent because the Feed was directed to the third column in this batch. Similarly, Recondition effluent is now in the first column effluent. Polish effluent is now in the second column effluent. Therefore, Polish effluent is distributed from the third primary port (V2) to a Polish effluent collection chamber. Feed effluent is distributed from the first primary port (V2) directly to the third primary port (V1) (or, alternatively, to a Feed effluent collection chamber). Recondition effluent is distributed from the second primary port (V2) to a Recondition effluent collection chamber.

Hence, this embodiment of the invention illustrates a distribution and processing apparatus that significantly reduces the number of valves needed to perform the three-part duty rotation as described above. Instead of a minimum of twelve single input three output multi-port valves or over thirty single input single output valves, only two valves are required. Those skilled in the art appreciate that different embodiments of the invention may use a first and a second valve with more than (or less than) three primary ports, cavities, conduits, openings, and secondary ports.

### BRIEF DESCRIPTION OF THE DRAWINGS

Further advantages of the invention are apparent by reference to the detailed description when considered in conjunction with the figures, which are not to scale, so as to more clearly show the details, wherein like reference numbers indicate like elements throughout the several views, and wherein:

FIG. 1 is a cutaway view looking from the side of a housing and a view of a core of a valve.

FIG. 2 is a view looking from the side of a core.

FIG. 3 is a side view looking at the outside of a housing, comprising a part of one of the embodiments of the present invention.

FIG. 4 is a side view looking at the outside of a housing.

FIG. 5 is a view looking down at the top of a core.

FIG. 6 is a schematic view of prior art apparatus utilizing three ion exchange reactors in parallel formation.

FIG. 7 is a schematic view of an apparatus utilizing one of the embodiments of the present invention.

FIG. 8 is a cutaway view looking from the side of a housing and a view of a core.

FIG. 9 is a view looking from the side of a core.

FIG. 10 is a schematic view of a method illustrating a preferred embodiment of the present invention.

### DETAILED DESCRIPTION

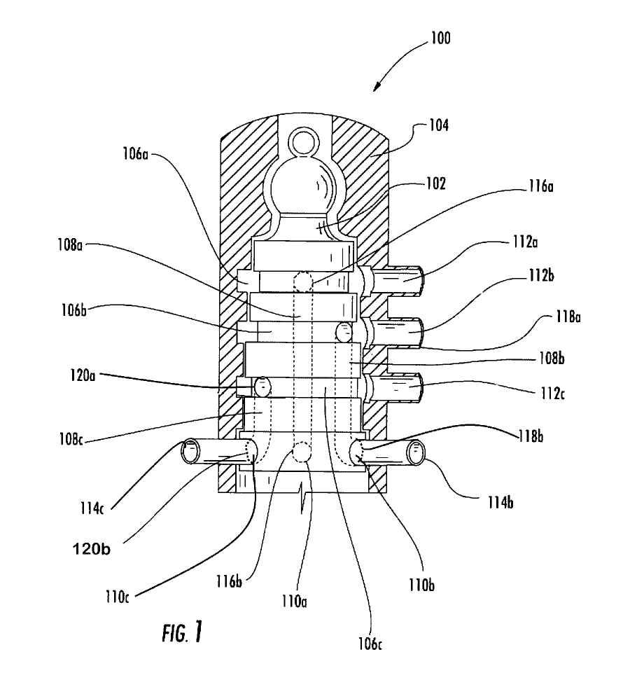

An overview of a preferred embodiment of the invention is shown in FIG. 1, displaying a distribution valve 100. The valve includes a core 102 and a housing 104. In this embodiment, the housing 104 substantially covers the core 102. The core 102 includes a first cavity 106a, a second cavity 106b, and a third cavity 106c. The core also includes a first conduit 108a, a second conduit 108b, and a third conduit 108c. Additionally, the core includes a first opening 110a, a second opening 110b, and a third opening 110c.

The housing 104 includes a first primary port 112a, a second primary port 112b, and a third primary port 112c. The housing 104 also includes a first secondary port 114a, a second secondary port 114b, and a third secondary port 114c.

For the purposes of this embodiment and all other embodiments discussed herein, the definitions for noted terms shall apply as follows:
a. Pipe: the term “pipe” or any version thereof is meant to be understood in a broad sense to include the concept of a passageway, conduit, tube channel, duct, or other similar structure. Moreover, the term is meant to encompass such structures of various sizes including very massive and lengthy structures as well as very small structures and short structures. The term pipe is not meant to be limited to any type of material unless otherwise disclosed in this detailed description.
b. Vertical: the term “vertical” or any other version thereof is not meant to be limited to a particular orientation. The term is used herein to aid the reader at setting a particular frame of reference with the figures provided.
c. Elevation: the term “elevation” or any other version thereof is not meant to be limited to a particular orientation. The term is used herein to aid the reader at setting and gauging a particular frame of reference with the figures provided.
d. Solution: the term “solution” is not meant to be limited to common notions of a specific type of mixture containing a solute and solvent. Rather, the term should be interpreted herein to encompass any type of liquid mixture, regardless of whether a physically defined solute and solvent are actually present.
e. Fluid: the term “fluid” as used herein is meant to connote a broad definition including any type of matter capable of behaving in a flexible, fluid manner.
f. And: the term “and” as used herein is meant to connote the dictionary meanings of both the terms “and” and “or.” For example, use of the term “and” essentially means “and/or.”

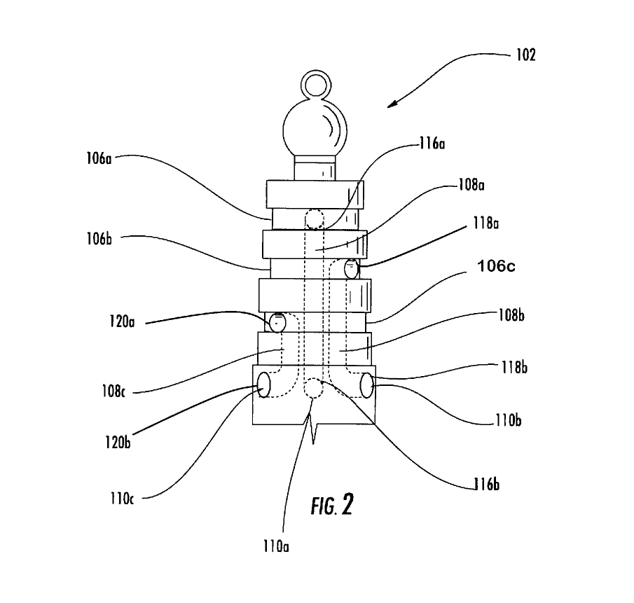

Referring back to the embodiment shown in FIG. 1, the core 102 is a tapered plug-like object that fits within the housing 104 such that the core 102 and the housing 104 may be rotated relative to one another. FIG. 2 displays the core 102 by itself without the housing 104. The core 102 may be made of a variety of different materials depending on the particular application for which the distribution valve 100 is being used. For example, low pressure and ambient temperature applications may allow for the valve 100 to be made of polymers or even more brittle materials. High pressure applications with corrosive fluids may require heavy duty plastic or rubber materials. High pressure or high temperature applications may require one of many metal compositions, including a wide array of metal alloys. In summary, the material used as the core 102 may contain or be made of any number of different materials or material combinations now known or later developed as long as the core is able to function properly as described herein. Though the cavities 106a, 106b, and 106c are defined along the core 102 in this particular embodiment, it should be understood by those skilled in the art that the cavities in other embodiments may be defined wholly along a corresponding housing. Alternatively, cavities found in another embodiment may be partially defined in a core and partially defined in a corresponding housing. In still another embodiment, the cavities could be located partially in a seal or “seat” between a core and a housing.

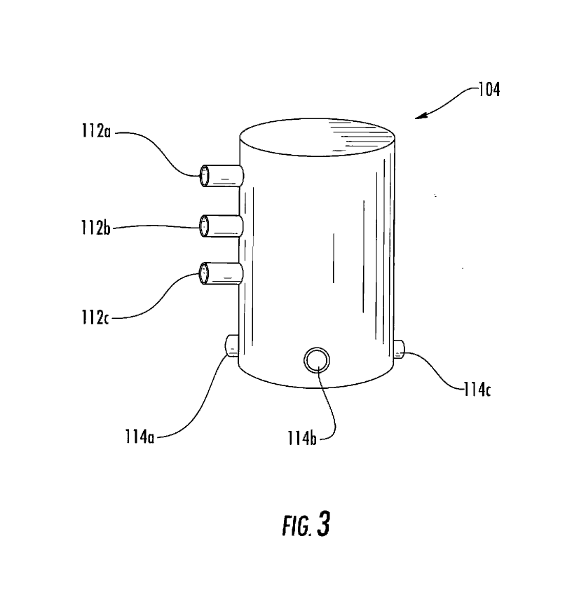

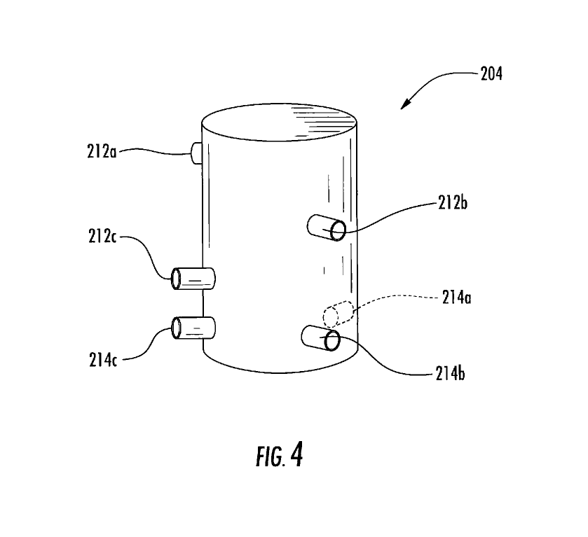

The housing 104, like the core 102, may be made of a number of different types of materials or material combinations. The primary requirement for choice of material is whether the housing 104 can function properly when used with applications similar to those described or inferred herein. In the particular embodiment shown in FIG. 1, the primary ports 112a, 112b, and 112c are shown as short passageways with fluid communication with the first cavities 106a, 106b, and 106c, respectively. As shown in FIG. 3, the primary ports 112a, 112b, and 112c protrude out from the outer surface of the housing 104 to allow for a pipe or other structure to be attached. The primary ports 112a, 112b, and 112c extend and are aligned in a linear vertical fashion in this particular embodiment. In a related embodiment, FIG. 4 shows a housing 204 on which all of three primary ports 212a, 212b, and 212c are not vertically aligned with one another. FIG. 4 also shows secondary ports 214b and 214c at the same elevation along the housing 204.

It should be understood by those skilled in the art that the primary ports in various embodiments of the invention may be aligned in any fashion with one another depending on the requirements of the particular application as long as the cavities (like 106a, 106b, and 106c) that correspond to the primary ports (like 112a, 112b, and 112c) are vertically separate and substantially no fluid mixing occurs between the cavities (like 106a, 106b, and 106c). It should also be understood that that the protrusion of the primary ports 112a, 112b, and 112c is not a requisite of the invention. The protruding characteristic of the primary ports 112a, 112b, and 112c is merely shown as a characteristic of these particular embodiments. Other embodiments may not include primary ports that protrude from the housing. Moreover, the outer shape of the housing 104 (or 204) may vary significantly in various embodiments as long as the valve 100 functions in a manner as described herein.

With reference back to FIG. 1 and FIG. 2, the cavities 106a, 106b, and 106c are located at different elevations along the outer surface of the core 102. The cavities 106a, 106b, and 106c are substantially annular spaces, each of which remains in substantially continuous fluid communication with one of the primary ports 112a, 112b, and 112c. For example, as the core 102 and the housing 104 rotate relative to one another, cavity 106a remains in fluid communication with primary port 112a, cavity 106b remains in fluid communication with primary port 112b, and cavity 106c remains in fluid communication with primary port 112c. The housing 104 and the core 102 are oriented and spaced with one another so that substantially no fluid from a particular cavity (106a, 106b, or 106c) mixes with the fluid in a separate cavity (106a, 106b, or 106c). In this particular embodiment, at least one layer of Fluorinated Ethylene Propylene (FEP) is located at the interface between the core 102 and the housing 104 to act as a seal (commonly referred to as a “seat”), minimizing intermixing between cavities 106a, 106b, and 106c. However, it should be understood by those skilled in the art that one or more materials other than or in addition to Fluorinated Ethylene Propylene (FEP) could be used in other embodiments as sealing aids to minimize intermixing between the applicable first cavities including, but not limited to, Perfluoroalkoxy (PFA), Polyvinylidene Fluoride (PVDF), Ethylene-tetrafluoroethylene (ETFE), and polytetraflouroethylene (PTFE).

In the embodiment shown in FIG. 1 and FIG. 2, a first conduit 108a, a second conduit 108b, and a third conduit 108c are located within the core 102. The first conduit 108a has a first end 116a and a second end 116b. The first end 116a is connected to the first cavity 106a and the second end 116b is connected to the first opening 110a, thereby allowing fluid communication between the first primary port 112a and the first opening 110a. The second conduit 108b has a first end 118a and a second end 118b. The first end 118a is connected to the second cavity 106b and the second end 118b is connected to the second opening 110b, thereby allowing fluid communication between the second primary port 112b and the second opening 110b. The third conduit 108c has a first end 120a and a second end 120b. The first end 120a is connected to the third cavity 106c and the second end 120b is connected to the third opening 110c, thereby allowing fluid communication between the third primary port 112c and the third opening 110c. The conduits 108a, 108b, and 108c described in this embodiment are essentially passageways that connect the cavities (106a, 106b, or 106c) to the openings (110a, 110b, or 110c), respectively.

The openings 110a, 110b, and 110c are located at substantially the same elevation with one another as shown in FIG. 1 and FIG. 2. In this embodiment, the openings 110a, 110b, and 110c are separated from one another by an angular distance, “d,” defined by the equation as follows:

d=(2·π·r)/3

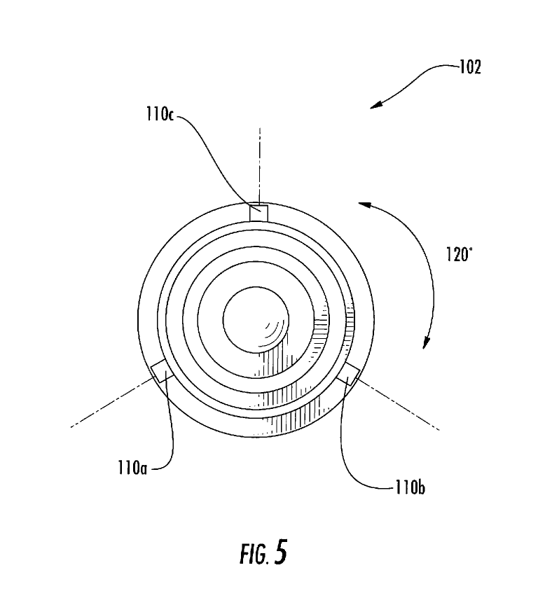

In the equation given above, the variable “r” is defined as the length value of the radius of the core. FIG. 5 shows a top-down perspective view of this particular embodiment of the core 102. The housing 104 and the core 102 are oriented and spaced with one another so that substantially no fluid from a particular second cavity mixes with the fluid in a separate second cavity. In this particular embodiment, at least one layer of Fluorinated Ethylene Propylene (FEP) is located at the interface between the core 102 and the housing 104 to minimize intermixing of openings 110a, 110b, and 110c. However, it should be understood by those skilled in the art that one or more materials other than or in addition to Fluorinated Ethylene Propylene (FEP) could be used in other embodiments as sealing aids to minimize intermixing between the applicable second cavities including, but not limited to, Perfluoroalkoxy (PFA), Polyvinylidene Fluoride (PVDF), Ethylene-tetrafluoroethylene (ETFE), and polytetraflouroethylene (PTFE).

In the particular embodiment shown in FIG. 1 and FIG. 2, the secondary ports 114a, 114b, and 114c are shown as short passageways with transient fluid communication with each of the openings 110a, 110b, and 110c. The secondary ports 114a (not shown), 114b, and 114c are spaced apart in the housing 104 so as to simultaneously be in fluid contact with a separate opening 110a, 110b, and 110c. For example, if secondary port 114a is in fluid communication with opening 110a, then, simultaneously, secondary port 114b will be in fluid communication with opening 110b and secondary port 114c will be in fluid communication with opening 110c. If and when the core 102 housing 104 rotate relative to each other such that the secondary port 114a becomes in fluid communication with opening 110b, then, simultaneously, secondary port 114b will be in fluid communication with opening 110c and secondary port 114c will be in fluid communication with opening 110a.

As shown in FIG. 1 and FIG. 3, the secondary ports 114a, 114b, and 114c each protrude out from the outer surface of the housing 104 to allow for a pipe or other structure to be attached. As with the primary ports, it should be understood by those skilled in the art that that the protrusion of the secondary ports 114a, 114b, and 114c is not a requisite of the invention. The protruding characteristic of the secondary ports 114a, 114b, and 114c is merely shown as a characteristic of this particular embodiment. Other embodiments may not include primary ports and secondary ports that protrude from the housing.

The size of the valve 100 will depend on the particular application. Any system now known or later developed that uses valve technology to transfer and alternate fluid stream flows in a stepwise fashion could potentially use this or other embodiments of the invention as discussed herein. Therefore, the size of the actual valve 100 is relative to the application.

One particular application for the embodiment shown in FIG. 1 is use in ion exchange systems. Ion exchange systems are used by a large number of industries including, but not limited to, water purification, water treatment, nuclear decontamination, power generation, pharmaceuticals, specialty chemicals, semiconductor manufacturing, hydrometallurgy, medicine, and chemical separations. The basic principle behind ion exchange is found in the name itself: the exchange of ions.

One type of ion exchange device is an ion exchange column. Often, multiple columns are used simultaneously in a given ion exchange system. In the industries listed above (as well as others), a common goal is to remove one type of ion in exchange for another type of ion in a fluid mixture. The science of and technology behind basic ion exchange is well known to those skilled in the art. Therefore, details of the fundamental background information on ion exchange will not be discussed here. However, it should be noted by those skilled in the art that various embodiments of the present invention may be used with practically any form of ion exchange technology that uses two ion exchangers in parallel formation or three or more in parallel formation and operated in series or counter-current fashion with respect to the feed solution and operated in parallel with respect to the regenerative feed.

Certain industries employ ion exchange systems that undergo three primary steps during operation. Those steps include a feed step, a reconditioning step (which is sometimes referred to as an elution step or “elute”), and a polishing step (which is use of the effluent of the feed column). In order to maximize efficiency, it is often desirable to operate sets of three ion exchange columns simultaneously so that, during operation, at least one column will substantially always be undergoing a feed step, at least one column will substantially always be undergoing a reconditioning step, and at least one column will substantially always be undergoing a polishing step.

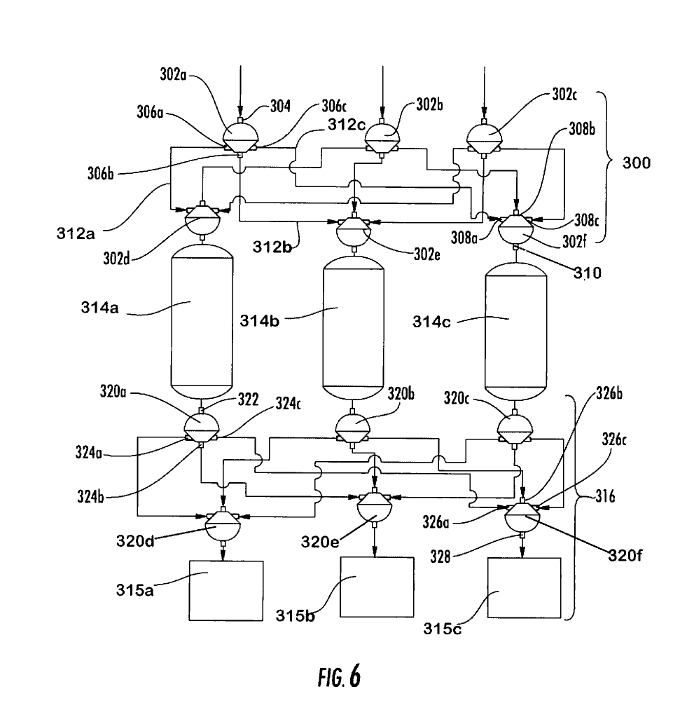

In order to direct the desired type of material (reaction mixture) to the correct ion exchange column presently requires a somewhat complex piping and valve assembly. For this three-column example application, at least six multiport valves would be required, each valve having at least one common input port and three separate output ports. FIG. 6 shows a schematic diagram of a prior art ion exchange feed system array 300. The feed system array 300 contains at least six multiport feed valves three of which are first feed valves 302a, 302b, and 302c and three of which are second feed valves 302d, 302e, and 302f. Each first feed valve (302a, 302b, and 302c) has one input port and three output ports. For example, valve 302a has input port 304 and output ports 306a, 306b, and 306c. Each second feed valve (302d, 302e, and 302f) has one output port and three input ports. For example, feed valve 302f has input ports 308a, 308b, and 308c and output port 310. Each first feed valve has a pipe attached to each output port. For example, pipe 312a is attached to output port 306a, pipe 312b is attached to output port 306b, and pipe 312c is attached to output port 306c. Pipes 312a, 312b, and 312c are also attached to second feed valves 302d, 302e, and 302f, respectively. Second feed valve 302d is further attached to first ion exchange column 314a, second feed valve 302e is attached to second ion exchange column 314b, and second feed valve 302f is attached to third ion exchange column 314c. When all six feed valves (302a, 302b, 302c, 302d, 302e, and 302f) are considered, a total of at least nine pipes must link the first feed valves 302a, 302b, and 302c to the second feed valves 302d, 302e, and 302f.

The leftover reacted material, or “effluent,” from each parallel ion exchange column (310a, 310b, and 310c) must be directed somewhere. In many ion exchange applications, it is desirable to recycle certain effluent streams. In some applications, the effluent streams contain hazardous waste that must be discarded in a specific manner. Therefore, as shown in FIG. 6, it is often desirable to keep effluent streams separate and store all feed effluent in a first chamber 312a, all recondition effluent in a second chamber 312b, and all polish effluent in a third chamber 312c. Because different effluent types flow from each ion exchange column after each separate ion exchange step, an effluent system array 316 must be used to redirect the effluent streams from columns 310a, 310b, and 310c to the desired chamber (312a, 312b, and 3 12c). As with the feed system array 300, the effluent system array 316 includes at least six multiport effluent valves, three of which are first effluent valves 320a, 320b, and 320c and three of which are second effluent valves 320d, 320e, and 320f Each first effluent valve (320a, 320b, and 320c) has one input port and three output ports. For example., valve 320a has input port 322 and output ports 324a, 324b, and 324c. Each second effluent valve (320d, 320e, and 320f) has one output port and three input ports. For example, effluent valve 320f has input ports 326a, 326b, and 326c and output port 328. Like the feed system array 300, the effluent system array 316 requires a minimum of nine pipes between the first effluent valves (320a, 320b, and 320c) and the second effluent valves (320d, 320e, and 320f).

The three step ion exchange system just described comes with many challenges including the following: (1) significant space is required for the large number of pipes and valves necessary to connect all parts of the ion exchange system; (2) most of the pipes at any one time are not in use (i.e., they become deadlegs); (3) the large number of pipes in the structure increase maintenance costs; (4) the increased complexity of using at least twelve multiport valves increases the chances for operator and system error in the form of failure to switch the valves in sequence correctly. Therefore, it is desirable to use less valves and a less complex piping system to minimize the challenges listed above.

The embodiment of the invention shown in FIG. 1 and FIG. 2 offers a solution to the challenges inherent in the ion exchange application outlined above and other similar fluid distribution applications. Instead of using twelve multiport valves, only two valves may be successfully used. Instead of allowing for two of every four pipes connected to each multiport valve to act as deadlegs during operation, the distribution and processing apparatus described herein allows for virtually no deadlegs. Instead of the need to accurately manipulate twelve valves during the operation of a three-step duty cycle ion exchange system, only two valves would need to be manipulated.

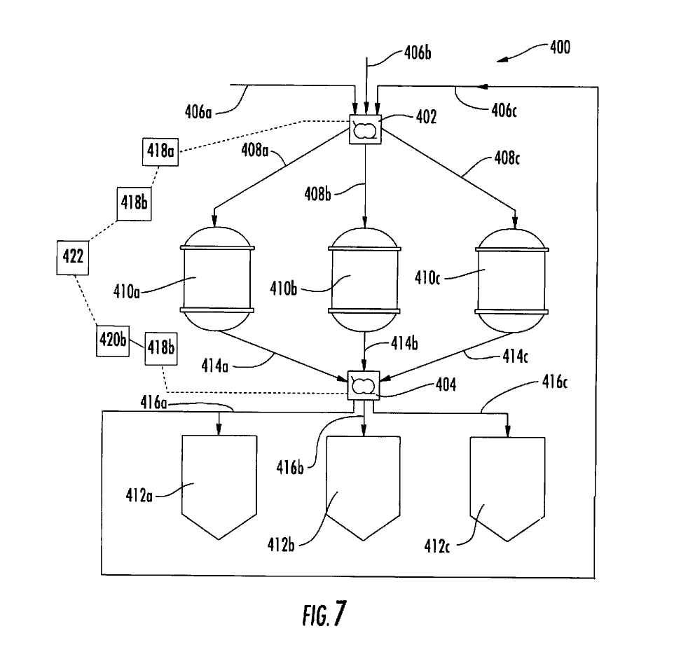

A schematic diagram of this embodiment of the invention as used in this ion exchange application is shown in FIG. 7. The three-step fluid distribution and processing apparatus 400 is shown in FIG. 7 with a feed valve 402 and an effluent valve 404, wherein both valves 402 and 404 are substantially identical to the valve shown in FIG. 1. Three types of reactant solutions are directed to the feed valve 402 including a feed line 406a, recondition line 406b, and polish line 406c. First transport line 408a carries a selected reactant solution to the first ion exchange column 410a, second transport line 408b carries a separate selected reactant solution to the second ion exchange column 410b, and third transport line 408c carries a still separate selected reactant solution to the third ion exchange column 410c.

During a first step of ion exchange operation, first transport line 408a would, for example, carry Feed solution, second transport line 408b would carry Recondition solution, and third transport line 408c would carry Polish solution. When the time comes for a second step in the ion exchange system 400, first transport line 408a would carry Recondition solution, second transport line 408b would carry Polish solution, and third transport line 408c would carry Feed solution. In a third step of the ion exchange rotation cycle, first transport line 408a would carry Polish solution, second transport line 408b would carry Feed solution, and third transport line 408c would carry Recondition solution. The cycle would then start over again with Feed solution flowing through first transport line 408a to the first ion exchange column 410a, Recondition solution flowing through second transport line 408b to the second ion exchange column 410b, and Polish solution flowing through third transport line 408c to the third ion exchange column 410c.

As with the feed solution, recondition solution, and polish solution being directed to a particular ion exchange column (410a, 410b, and 410c), the effluent solution from each ion exchange column (410a, 410b, and 410c) is directed to a particular location. The effluent from the column undergoing Feed (Feed effluent) is preferably sent directly to feed valve 402 to be directed to the column to receive the Polish. Alternatively, the Feed effluent could be directed to an effluent feed chamber 412a. The effluent from the column receiving Recondition (Recondition effluent) is directed to an effluent recondition chamber 412b and the effluent from the column receiving Polish (Polish effluent) is directed to an effluent polish chamber 412c, respectively. In a first step of the ion exchange rotation cycle, Feed effluent from the first ion exchange column 410a is directed to effluent valve 404 through fourth transport line 414a, Recondition effluent from the second ion exchange column 410b is directed to effluent valve 404 through fifth transport line 414b, and Polish effluent from the third ion exchange column 410c is directed to effluent valve 404 through sixth transport line 414c. In a second step of the ion exchange rotation cycle, Recondition effluent from the first ion exchange column 410a is directed to effluent valve 404 through fourth transport line 414a, Polish effluent from the second ion exchange column 410b is directed to effluent valve 404 through fifth transport line 414b, and Feed effluent from the third ion exchange column 410c is directed to effluent valve 404 through sixth transport line 414c. In a third step of the ion exchange rotation cycle, Polish effluent from the first ion exchange column 410a is directed to effluent valve 404 through fourth transport line 414a, Feed effluent from the second ion exchange column 410b is directed to effluent valve 404 through fifth transport line 414b, and Recondition effluent from the third ion exchange column 410c is directed to effluent valve 404 through sixth transport line 414c.

During all steps of the ion exchange rotation cycle, Feed effluent is sent from effluent valve 404 to the feed valve 402 to be introduced as Polish for the column undergoing a polishing step (or, alternatively, to an effluent feed chamber 412a) via effluent feed line 416a. Preferably, effluent line 416a transitions into or otherwise becomes polish line 406c. Similarly, during all steps of the ion exchange rotation cycle, Recondition effluent is sent from effluent valve 404 to the effluent recondition chamber 412b via effluent recondition line 416b. Also, during all steps of the ion exchange rotation cycle, Polish effluent is sent from effluent valve 404 to the effluent polish chamber 412c via effluent polish line 416c.

The fluid distribution and process apparatus 400 described above also preferably includes a first actuator 418a and second actuator 418b for feed valve 402 and effluent valve 404, respectively. In a preferred embodiment, the first actuator 418a and the second actuator 418b are controllably linked to a first controller 420a and a second controller 420b, respectively, whereby the controllers 420 direct the actuators 418 to manipulate the valves 402 and 404, respectively. In a particularly preferred embodiment, the controllers 420 are linked to a control system 422 whereby the control system provides control coordination between controllers 420.

Some of the benefits from use of the feed valve 402, the effluent valve 404, and the embodiment including the fluid distribution and processing apparatus 400 include the following: (1) only two valves are necessary instead of twelve or more, thereby saving space required by the other unneeded valves; (2) only six transport lines (408a, 408b, 408c, 414a, 414b, and 414c) are necessary instead of eighteen or more, thereby saving much space and minimizing maintenance requirements; (3) only two valves must be manipulated instead of twelve or more, thereby minimizing the chance of operator or system error.

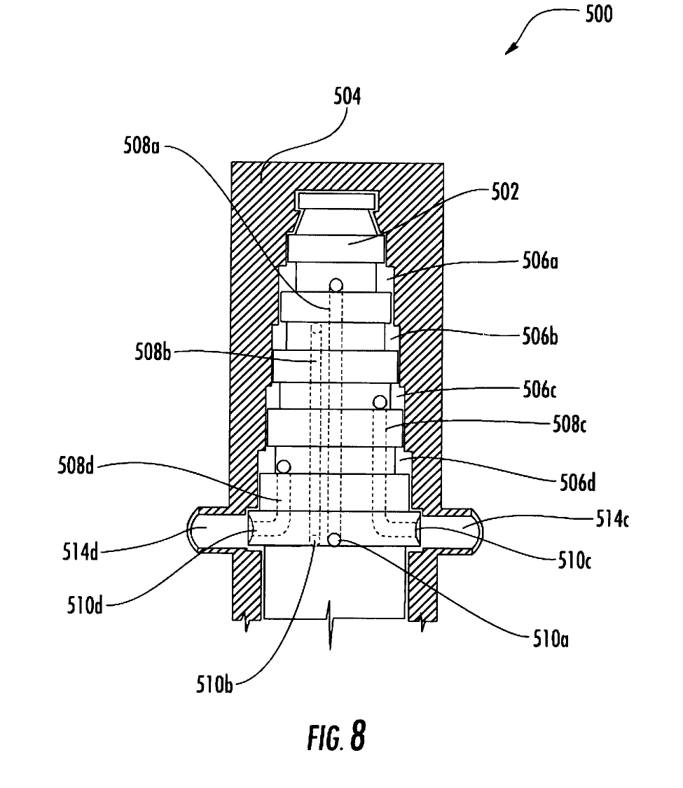

Though a three-step ion exchange system example has been discussed, it should be understood by those skilled in the art that valves constructed based on the principles of the embodiments of the invention discussed herein may be created that address two or more step systems from various arts. For example, FIG. 8 shows one embodiment of the present invention including a distribution valve 500 with a core 502 and a housing 504. The valve 500 shown in FIG. 8 has four cavities (506a, 506b, 506c, and 506d), four conduits (508a, 508b, 508c, 508d), four openings (510a, 510b, 510c, and 510d), four primary ports (not shown), and four secondary ports (514a (not shown), 514b (not shown), 514c, and 514d). The valve 500 operates in a similar fashion as valve 100, except that valve 500 is adapted for a four step fluid distribution process as opposed to a three step process.

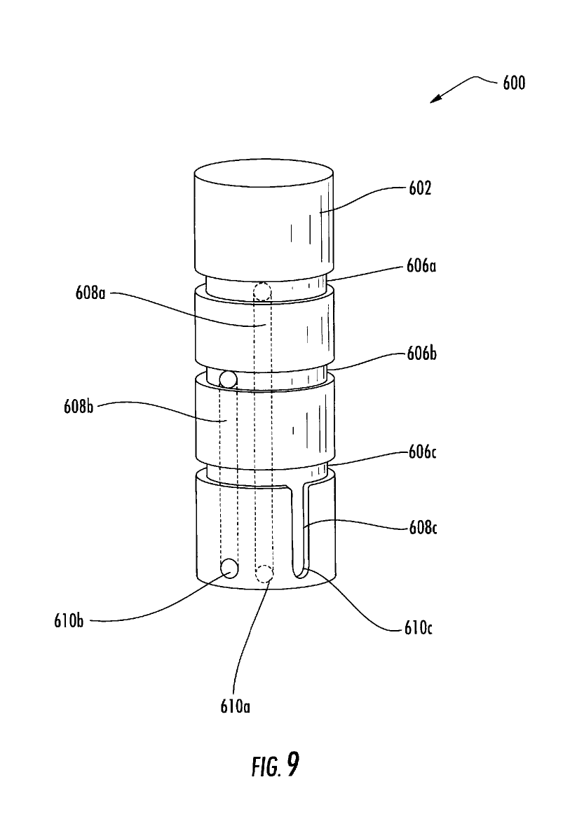

FIG. 9 shows yet another embodiment of the invention, displaying the core 602 of a distribution valve 600 (partially shown). The embodiment shown in FIG. 9 includes a housing 604, three cavities (606a, 606b, and 606c), three conduits (608a, 608b, and 608c), three openings (610a, 610b, and 610c), three primary ports (not shown), and three secondary ports (not shown). The purpose of discussing this particular embodiment is to show that the conduits found in various embodiments of the invention do not all have to be passageways found completely within the cores. As shown in FIG. 9, conduit 608c remains on fluid communication with cavity 606c and second cavity 610c, but conduit 608c is partially enclosed by the housing 604 when the core 602 is located substantially within the housing 604.

It should be understood that various embodiments of the valve apparatus described above may be used individually, in parallel, in series, or in any way that is deemed beneficial to a user. More specifically, the various valves discussed above need not be used in groups of two or more.

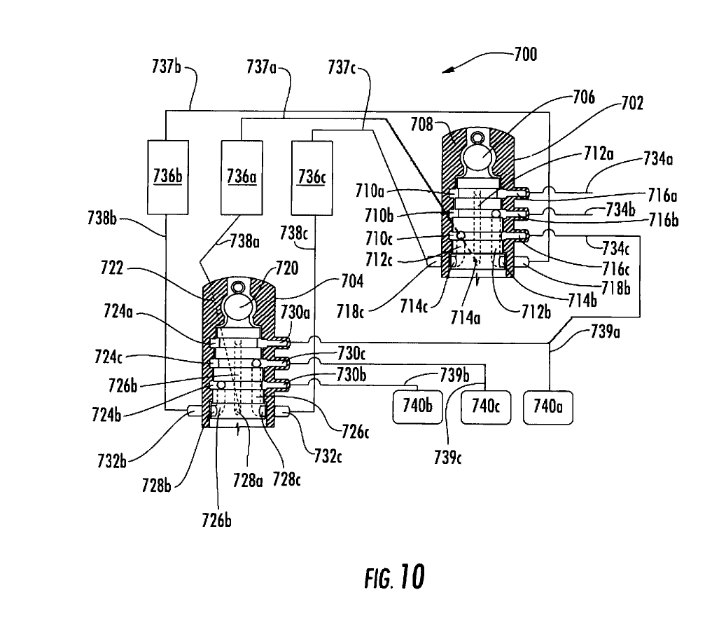

FIG. 10 shows a diagram of another embodiment, including a fluid distribution and processing apparatus 700, further including a feed valve 702 and an effluent valve 704. The feed valve 702 includes a core 706 and a housing 708. The core 706 further includes three cavities (710a, 710b, and 710c), three conduits (712a. 712b, and 712c), and three openings (714a, 714b, and 714c). The housing 708 further includes three primary ports (716a, 716b, and 716c) and three secondary ports (718a (not shown), 718b, and 718c). The effluent valve 704 also contains a core 720 and a housing 722. The core 720 further includes three cavities (724a, 724b, and 724c), three conduits (726a, 726b, and 726c), and three openings (728a, 728b, and 728c). The housing 722 further includes three primary ports (730a, 730b, and 730c) and three secondary ports (732a (not shown), 732b, and 732c).

The apparatus 700 includes three supply streams of a separate input composition wherein each stream is named for each duty as follows: “Feed” supply stream, “Recondition” supply stream, and “Polish” supply stream. Each individual supply stream is directed to the three separate primary ports (716a, 716b, and 716c) located on the housing 708 of the feed valve 702 via feed supply pipes 734a, 734b, and 734c. The feed valve 702 of this embodiment is a valve substantially identical to the valve described previously and displayed in FIG. 1 and FIG. 2. Feed solution is directed to the first primary port 716a, Recondition solution is directed to the second primary port 716b, and Polish solution is directed to the third primary port 716c. For example, in a first step of the three-part duty rotation cycle, Feed solution flows from the Feed supply pipe 734a into the first primary port 716a, into the first cavity 710a, through the first conduit 712a, out of the first opening 714a, and out of the first secondary port 718a to a first column 736a in the ion exchange system 700 distributed via a first transport pipe 737a. At substantially the same time, Recondition solution flows from the Recondition supply pipe 734b into the second primary port 716b, into the second cavity 710b, through the second conduit 712b, out of the second opening 714b, and out of the second secondary port 718b to a second column 736b in the ion exchange system 700 distributed via a second transport pipe 737b. At substantially the same time, Polish solution flows from the Polish supply pipe 734c into the third primary port 716c, into the third cavity 710c, through the third conduit 712c, out of the third opening 714c, and out of the third secondary port 718c to a third column 736c in the ion exchange system 700 distributed via a third transport pipe 737c. As the Feed solution flows through the first column 736a and reacts, Recondition solution flows through the second column 736b and reacts and Polish solution flows through the third column 736c and reacts. The effluent solutions from each column (736a, 736b, and 736c) are directed to the effluent valve 704. A first Feed effluent flows from the first column 736a, a first Recondition effluent flows from the second column 736b, and a first Polish effluent flows from the third column 736c.

The effluent valve 704 is used in this embodiment similarly to the first valve; however, the respective fluid flows through the effluent valve 704 move through the effluent valve 704 in the opposite manner than with the feed valve 702. More specifically, a first column effluent transport line 738a is connected to the first secondary port 732a of the effluent valve 704. The second column effluent transport line 738b is connected to the second secondary port 732b of the effluent valve 704. The third column effluent transport line 738c is connected to the third secondary port 732c of the effluent valve 704.

The first column effluent is directed through the first secondary port 732a, the first opening 728a, the first conduit 726a, the first cavity 724a, and the first primary port 730a. The second column effluent is directed through the second secondary port 732b, the second opening 728b, the second conduit 726b, the second cavity 724b, and the second primary port 730b. The third column effluent is directed through the third secondary port 732c, the third opening 728c, the third conduit 726c, the third cavity 724c, and the third primary port 730c. Feed effluent, the contents of a first “batch” (or “run” or “duty”) of the first column effluent, is preferably distributed from the first primary port 730a to the third primary port 716c. Alternatively, the Feed effluent may be distributed to a Feed effluent collection chamber 740a via a first effluent chamber pipe 739a. Recondition effluent, the contents of the first batch of the second column effluent, is distributed from the second primary port 730b to a Recondition effluent collection chamber 740b via a second effluent chamber pipe 739b. Polish effluent, the contents of the first batch of the third column effluent, is distributed from the third primary port 730c to a Polish effluent collection chamber 740c via a third effluent chamber pipe 739c.

When the time comes for the ion exchange system 700 to change duties for each ion exchange column (i.e., conduct another “run,” or run a new “batch”), the core 704 and the housing 706 of the feed valve 702 are moved relative to each other to accomplish the following: Feed solution continues to be directed to the first primary port 716a via the Feed supply pipe 734a, Recondition solution continues to be directed to the second primary port 716b via the Recondition supply pipe 734b, and Polish solution continues to be directed to the third primary port 716c via the Polish supply pipe 734c. Feed solution flows into the first primary port 716a, into the first cavity 710a, through the first conduit 712a, out of the first opening 714a, and out of the third secondary port 718c to the third column 736c via pipe 737c in the ion exchange system 700. At substantially the same time, Recondition solution flows into the second primary port 716b, into the second cavity 710b, through the second conduit 712b, out of the second opening 714b, and out of the first secondary port 718a to the first column 736a via pipe 737a in the ion exchange system 700. At substantially the same time, Polish solution flows into the third primary port 716c, into the third cavity 710c, through the third conduit 712c, out of the third opening 714c, and out of the second secondary port 718b to the second column 736b via pipe 737b in the ion exchange system 700. As the Feed solution flows through the third column 736c, Recondition solution flows through the second column 736b, and Polish solution flows through the second column 736b, the effluent flows from each column (736a, 736b, and 736c) are directed to the effluent valve 704.

When the time comes for the ion exchange system 700 to change duties for each ion exchange column (736a, 736b, and 736c) and substantially when the feed valve 702 is manipulated as described above, the core 720 and the housing 722 of the effluent valve 704 are moved relative to each other to accomplish the following: The first column effluent solution continues to be directed to the first secondary port 732a. The second column effluent solution continues to be directed to the second secondary port 732b. The third column effluent solution continues to be directed to the third secondary port 732c. The first column effluent solution flows through the first secondary port 732a, the second opening 728b, the second conduit 726b, the second cavity 724b, and the second primary port 730b. The second column effluent solution flows through the second secondary port 732b, the third opening 728c, the third conduit 726c, the third cavity 724c, and the third primary port 730c. The third column effluent solution flows through the third secondary port 732c, the first opening 728a, the first conduit 726a, the first cavity 724a, and the first primary port 730a. During this duty cycle, Feed effluent solution is no longer flowing from first column 736a because the Feed solution was directed to the third column 736c in this particular batch. Therefore, Recondition effluent is now flowing from the first column 736a to the effluent valve 704 and Polish effluent is now flowing from the second column 736b to the effluent valve 704. Polish effluent is again distributed from the third primary port 730c to the Polish effluent collection chamber 740c. Feed effluent is again distributed from the first primary port 730a to primary port 716c on the feed valve 702 (or, alternatively, to the Feed effluent collection chamber 740a). Recondition effluent is again distributed from the second primary port 730b to the Recondition effluent collection chamber 740b.

When the time comes for the feed valve 702 and the effluent valve 704 to be manipulated for a third batch, the process outlined above repeats in a similar fashion so as to bring about the following: (1) the respective input solutions (Feed, Recondition and Polish) continue to be delivered to the same respective primary ports (716a, 716b, and 716c) on the feed valve 702 and (2) the respective effluent (output) solutions (Feed, Recondition, and Polish) continue to be distributed from the same respective primary ports (730a, 730b, and 730c) on the effluent valve 704.

The three-step fluid distribution and processing apparatus 700 described herein is merely one embodiment in one type of application (ion exchange). However, those skilled in the art will appreciate that the apparatus just described could be altered to incorporate any similar fluid exchange apparatus requiring at least two steps in which at least two different fluids are used in a stepwise system. For example, the distribution valve 500 in FIG. 8 could be used in a similar distribution and processing apparatus 700 as just described but with four fluid streams, wherein the distribution valve 500 is substituted for the feed valve 702 and the effluent valve 704. To illustrate another embodiment, distribution valve 600 from FIG. 9 could be substituted for the feed valve 702 and the effluent valve 704 in the fluid distribution and processing apparatus 700 described in detail above. The number of input streams in a given fluid distribution apparatus would ultimately determine what embodiment of the present invention should be used because the number of streams would determine the number of cavities, conduits, openings, primary ports, and secondary ports for the core and the housing of a given valve.

The invention described herein also includes a method for distributing fluid using the various fluid distribution apparatus embodiments described herein. In one embodiment, the method includes the steps of (1) receiving at least three separate fluids at a single distribution apparatus including a first fluid, a second fluid, and an third fluid; (2) distributing the at least three fluids to a separate fluid receiver such that the first fluid is received at a first fluid receiver, the second fluid is received at a second receiver, and the third fluid is received at a third receiver; (3) and manipulating the single fluid distribution apparatus such that the first fluid is received at the third receiver, the second fluid is received at the first receiver, and the third fluid is received at the second receiver. Only one fluid distribution apparatus and one manipulation step is required in this embodiment to distribute three or more liquids in an alternative fashion as described above. It is understood by those skilled in the art that any number of separate fluids could be successfully distributed by the method described above depending on the size of the valve and the availability of space for multiple fluid transport paths. The term “fluid receiver” is to be interpreted broadly and is meant to encompass any object, container, or three-dimensional zone (bounded or unbounded) capable of receiving a fluid including, but not limited to, a pipe, a reservoir, a sponge, a volume of a gas or mixture of gases, and a vacuum.

The foregoing description of certain exemplary embodiments of the present invention has been provided for purposes of illustration only, and it is understood that numerous modifications or alterations may be made in and to the illustrated embodiments without departing from the spirit and scope of the invention as defined in the following claims.

What is claimed is:

1. A valve apparatus comprising:
(a) a core including
i. a plurality of cavities;
ii. a plurality of openings;
iii. a plurality of conduits, each conduit having a first end and a second end, the first end of each conduit being connected to a separate cavity and the second end of each conduit defining one of the plurality of openings; and
(b) a housing at least partially covering the core, the housing including
i. a plurality of primary ports, each primary port remaining in substantially continuous fluid communication with one of the plurality of cavities; and
ii. a plurality of secondary ports, each secondary port being in transient fluid communication with one of the plurality of openings.

2. The valve apparatus of claim 1, wherein at least one cavity is defined along the core.

3. The valve apparatus of claim 1 wherein at least one cavity is defined along the housing.

4. The valve apparatus of claim 1, wherein at least one cavity is defined along the core and the housing.

5. The valve apparatus of claim 1, wherein each cavity is located at a different elevation along the valve apparatus.

6. The valve apparatus of claim 1, wherein each cavity comprises an annular groove.

7. The valve apparatus of claim 1, the valve apparatus further comprising at least one seal layer located between the core and the housing.

8. The valve apparatus of claim 1, wherein substantially no mixing occurs between each cavity.

9. The valve apparatus of claim 1 further comprising an opening configuration wherein the plurality of openings are each separated by an angular distance substantially determined by the following equation
d=(2·π·r)/n
wherein, “n” represents a variable that is equal to the number of openings in the valve, “r” represents a variable that is equal to the radius of the valve, and “d” represents a variable that is equal to the angular distance between openings.

10. The valve apparatus of claim 7, wherein the seal layer is selected from the group consisting of Fluorinated Ethylene Propylene (FEP), Perfluoroalkoxy (PFA), Polyvinylidene Fluoride (PVDF), Ethylene-tetrafluoroethylene (ETFE), and polytetraflouroethylene (PTFE).

11. A fluid distribution and processing apparatus, comprising
(a) a first valve including
i. a first input for receiving a first fluid, a second input for receiving a second fluid, and a third input for receiving a third fluid;
ii. a first output, a second output, and a third output for transiently distributing the first fluid, the second fluid, and the third fluid;
iii. the ability to move between three positions including
1. a first position where the first input, the second input, and the third input are connected to the first output, the second output, and the third output, respectively,
2. a second position where the first input, the second input, and the third input are connected to the third output, the first output, and the second output, respectively, and
3. a third position where the first input, the second input, and the third input are connected to the second output, the third output, and the first output;
(b) a second valve including
i. a fourth input, a fifth input, and a sixth input for transiently receiving a fourth fluid, a fifth fluid, and a sixth fluid;
ii. a fourth output for distributing a fourth fluid, a fifth output for distributing a fifth fluid, and a sixth output for distributing a sixth fluid:
iii. the ability to move between three positions including
1. a first position where the first input, the second input, and the third input are connected to the first output, the second output, and the third output, respectively,
2. a second position where the first input, the second input, and the third input are connected to the third output, the first output, and the second output, respectively, and
3. a third position where the first input, the second input, and the third input are connected to the second output, the third output, and the first output;
(c) a first fluid processor, a second fluid processor, and a third fluid processor, each fluid processor having an input and an output;
(d) a first pipe assembly connecting the first output, the second output, and the third output of the first valve to the first fluid processor input, the second fluid processor input, and the third fluid processor input, respectively;
(e) a second pipe assembly connecting the first fluid processor output, the second fluid processor output, and the third fluid processor output to the fourth input, the fifth input, and the sixth input of the second valve, respectively.

12. The fluid distribution and processing apparatus of claim 11, further comprising at least one limit switch for the first valve and at least one other limit switch for the second valve.

13. The fluid distribution and processing apparatus of claim 11, further comprising
(a) a first actuator for moving the first valve to the three valve positions of the first valve and a second actuator for moving the second valve to the three valve positions of the second valve; and
(b) an at least one controller linked to the first actuator and the second actuator for controlling the first actuator and the second actuator.

14. The fluid distribution and processing apparatus of claim 13, further comprising
a control system attached to the at least one controller for controlling the operation of the first valve and the second valve, thereby coordinating the flow and processing of fluid within the fluid distribution and processing apparatus.

15. The fluid distribution and processing apparatus of claim 13 wherein the actuators are air operated.

16. A method for distributing three or more separate fluids using a single fluid distribution apparatus, the method comprising the steps of
(a) receiving at least three separate fluids at a single fluid distribution apparatus including a first fluid, a second fluid, and a third fluid;
(b) distributing the at least three fluids to separate fluid receivers such that the first fluid is received at a first fluid receiver, the second fluid is received at a second receiver, and the third fluid is received at a third receiver; and
(c) manipulating the single fluid distribution apparatus such that the first fluid is received at the third receiver, the second fluid is received at the first receiver, and the third fluid is received at the second receiver.

17. The method of claim 16 further comprising the step of manipulating the single fluid distribution apparatus such that the first fluid is received at the second receiver, the second fluid is received at the third receiver, and the third fluid is received at the first receiver.
